(19) United States
(12) Patent Application Publication
(10) Pub. No.: US 2015/0129440 A1
(43) Pub. Date: May 14, 2015

(54) Firearm Storage Unit

(71) Applicant: Mario Abascal, Port St Lucie, FL (US)

(72) Inventor: Mario Abascal, Port St Lucie, FL (US)

(21) Appl. No.: 14/538,111

(22) Filed: Nov. 11, 2014

Related U.S. Application Data
(60) Provisional application No. 61/903,020, filed on Nov. 12, 2013.

(51) Int. Cl. F41C 33/06; B60N 3/00

(52) U.S. Cl. CPC F41C 33/06; B60N 3/00
USPC 206/317

(57) ABSTRACT

A gun holder for placement in the center console of a vehicle. The gun holder includes a horizontally disposed panel that includes a centrally located slot in which the barrel of a firearm can be placed and held therein, leaving the handle portion of the firearm exposed for easy access. The panel provides a substantially rectangular shape and is substantially planar. There are one or more slots having a base, sidewalls and an open upper in which firearm magazine clips can be inserted and held therein. The device further includes a plurality of recessed holes in which bullets can be inserted and stored. Two legs extend perpendicularly from a lower surface of the panel on opposing sides thereof for supporting the panel in an elevated position.

### CROSS REFERENCE TO RELATED APPLICATION

This application claims the benefit of U.S. Provisional Application No. 61/903,020 filed on Nov. 12, 2013. The above identified patent application is herein incorporated by reference in its entirety to provide continuity of disclosure.

### BACKGROUND OF THE INVENTION

1. Field of the Invention

The present invention relates to gun storage apparatuses. More specifically the invention relates to a gun storage apparatus that can be installed within the console of a vehicle for easy access thereto.

Conventional methods of storing and concealing guns often involve the use of gun holsters, racks, safes, and the like. However, these storage spaces are not adapted to fit within a vehicle. Thus, users often resort to storing a gun in a glove compartment or beneath the seat in an unsecured manner to which the gun can become tousled about as the vehicle moves, causing the gun to mistakenly fire. This is extremely unsafe to the user, other drivers as well as passengers in the vehicle.

More practical classes of gun holders provide racks that enable the firearm to remain in a sound position so that it does not become dislodged therefrom. Still, such holders do not provide additional areas for the storage of bullets and magazine clips and are not adapted to fit within a center console of a vehicle for quick and easy access thereto. As such, there exists a need for a gun storage unit that can fit within the interior volume of a vehicle center console in which a firearm, bullets and magazine clips can be inserted and held therein.

2. Description of the Prior Art

Devices have been disclosed in the prior art that relate to gun storage apparatuses. These include devices that have been patented and published in patent application publications. These devices generally relate to gun storage apparatuses. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 6,766,927 to Cart provides a gun holder for use in vehicles that provides a pair of bendable sidewalls having an interior volume in which a gun can be placed for storage. The device in its entirety can be placed in the space between the seats of a vehicle. The present invention however, provides a gun storage unit that can be applied to the center console of a vehicle and includes storage areas for bullets, a firearm, and a pair of slots for gun magazine clips.

U.S. Pat. No. 6,293,447 to Jorgensen discloses a vehicle gun carrier system for supporting a plurality of elongated guns, wherein the device includes a base portion, a support member, and straps. The device is positionable at a center console or armrest of a vehicle. While this may be helpful in the way of storing elongated guns, such as rifles, it offers little utility in the way of storing smaller sized handguns and the like in a discrete manner. Further the present invention provides storage spaced for bullets as well as magazine clips.

U.S. Patent No. 2012/0305613 to Allen discloses an automobile console pistol holster having adjustment screws to snugly secure a pistol placed therein. The device can be placed in the console portion of a vehicle. The present invention however, provides a gun storage unit that can be placed in the console portion of a vehicle for easy access thereof that includes slots for magazine clips, holes for bullet, and a space in which a handgun can fit.

U.S. Pat. No. 4,131,202 to Hansen describes a console having a receiver for a gun barrel and a groove portion in order to hold the stock of a rifle. The console further provides an access door to store other articles therein. However, the present invention provides a firearm storage unit that can be placed within the interior volume of a center console and includes slots for a magazine clips, a firearm, and additional storage spaces for a plurality of bullets.

U.S. Pat. No. 5,511,711 to Kunz provides a gun holder for use with a vehicle having a hinged lid and a housing, wherein the housing provides an interior in which a firearm can be placed. The lid further provides the appearance of an electronic device in order to deceive others so that it is not readily apparent that a firearm is held within. Still, the present invention provides a firearm storage unit that can be placed into the center console of a vehicle and provides slots for the insertion of magazine clips, bullets, and a firearm.

These prior art devices have several known drawbacks. The above discussed firearm storage units do not utilize a gun storage unit having a pair of legs that can be applied to the center console of a vehicle and includes a plurality of recessed holes for bullets, a central slot for a firearm, and a pair of slots for gun magazine clips. In light of the devices disclosed in the prior art, it is submitted that the present invention substantially diverges in design elements from the prior art and consequently it is clear that there is a need in the art for an improvement to existing firearm storage devices. In this regard the instant invention substantially fulfills these needs.

### SUMMARY OF THE INVENTION

In view of the foregoing disadvantages inherent in the known types of firearm storage apparatuses now present in the prior art, the present invention provides a new firearm storage unit, wherein the same can be utilized for providing convenience for the user when storing a firearm and accessories within a vehicle, wherein the invention can be placed in the console of a vehicle.

It is therefore an object of the present invention to provide a new and improved firearm storage device that has all of the advantages of the prior art and none of the disadvantages.

It is another object of the present invention to provide a firearm storage unit that is adapted to fit in the interior volume of a center console of a vehicle.

Another object of the present invention is to provide a firearm storage unit that provides a plurality of recessed holes in which bullets can be placed and stored.

Another object of the present invention is to provide a firearm storage unit that provides a centrally located slot for the insertion and storage of a firearm, such as a handgun or pistol.

Yet another object of the present invention is to provide a firearm storage unit having slots for the insertion and storage of firearm magazine clips.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a top view of the firearm storage apparatus having a centrally located firearm slot, a pair of slots for magazine clips, and a plurality of recessed holes.

FIG. 2 shows a perspective view of the firearm storage apparatus having an open bottom, wherein the device is adapted to fit in the center console portion of a vehicle.

### DETAILED DESCRIPTION OF THE INVENTION

Reference is made herein to the attached drawings. Like reference numerals are used throughout the drawings to depict like or similar elements of the firearm storage apparatus. For the purposes of presenting a brief and clear description of the present invention, the preferred embodiment will be discussed as used for storing bullets, a firearm, and magazine clips in the console of a vehicle. The figures are intended for representative purposes only and should not be considered to be limiting in any respect.

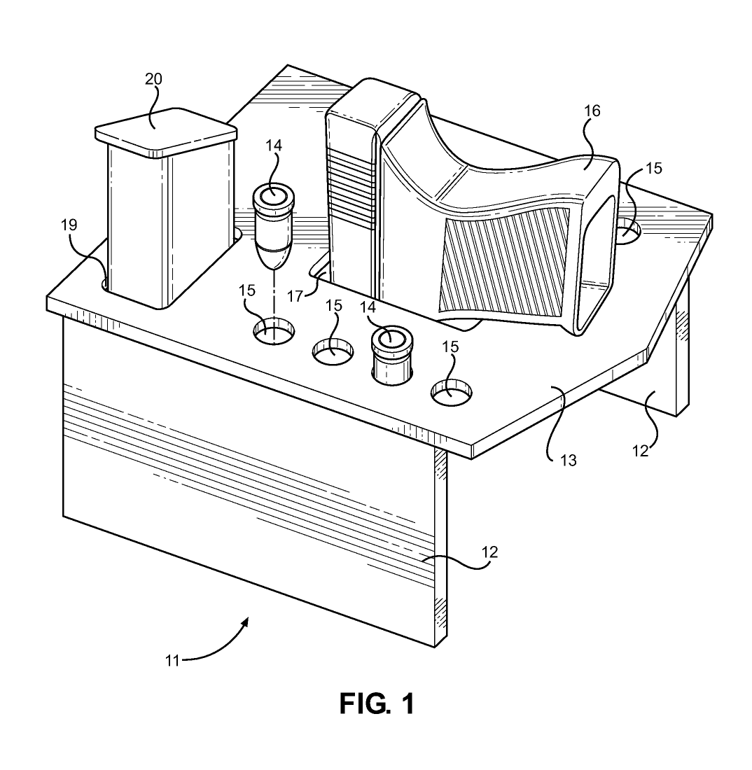

FIG. 1 shows a perspective view of an embodiment of the firearm storage unit 11 wherein the device is adapted to fit in the center console of a vehicle. In a preferred embodiment, the firearm storage unit 11 comprises a substantially rectangular panel 13 that includes a first side, a second side, and a perimeter edge having a pair of lengthwise and widthwise sides. The panel 13 is horizontally disposed and comprises a centrally located first slot 17 having a rectangular shape that is adapted to receive a handgun 16 therein. The first slot 17 provides an interior volume having an open upper, a base and sidewalls defining an interior volume, in which the barrel portion of a firearm can be inserted and can rest therein. The firearm storage unit 11 is not limited to having one slot for the placement of a firearm therein and can include at least one slot for the storage of a firearm and may comprise multiple slots for the storage of a plurality of firearms therein.

The firearm storage unit 11 provides a pair of legs 12 that are situated in a parallel orientation in relation to one another. The legs 12 comprise a rectangular shape in a preferred embodiment having a top, a bottom, an outer edge and a substantial size in order to enable the device to fit within a standard center console of a vehicle, wherein the center console provides sidewalls and a base defining an interior volume and having an open upper with a hingedly attached lid for placement thereover. The legs 12 are extend perpendicularly from the outer edge along the length of the panel 13 of the firearm storage unit 11; however the legs 12 extend from the second side of the panel 13 in a perpendicular orientation therefrom and along the length thereof in an alternative embodiment. In operation, the user can open the lid of the center console of a vehicle, thus revealing the interior volume, whereby the user can then place the bottom of the legs 12 of the firearm storage unit 11 into the interior volume of the center console such that the outer edge of the legs 12 contacts the base of the center console and rests thereagainst in a stable position.

One of the pair of widthwise sides provides a V-shaped structure adapted to provide a substantial surface area for the grip or handle portion of a firearm 16, such as a pistol placed within the first slot 17 to extend thereover the first side of the panel and to enable a user to more readily grasp and gain access to the grip or handle of the firearm, wherein the grip or handle portion of the firearm 16 will not contact the sidewall of the vehicle center console, thus allowing the easy lifting of the firearm from the first slot. The firearm storage unit 11 can be made in various sizes and shapes in order to accommodate different vehicle makes and models. The firearm storage unit 11 can be made from plastic, polymer, metal, stainless steel, wood, nylon, rubber, aluminum and/or other suitable materials.

The firearm storage unit 11 can be made in various arrangements, wherein there is one second slot 19 for one firearm magazine clip 20 in an alternative embodiment as shown, having a base and sidewalls defining an interior volume with an open upper in which a magazine clip 20 can be placed and held therein. There are recessed holes 15 that are circular in shape adapted to receive a standard bullet therein, wherein the recessed holes 15 comprise a base, sidewalls and an open upper. The user can thus readily gain access to the firearm 16 via pulling the handle thereof from the first slot 17 and thereafter grasping the base end of the magazine clip 20 and lifting it from the second slot 19. The user can then manually grasp one of the bullets 14, lifting the bullet 14 from one of the plurality of recessed holes 15 on the panel 13, wherein the user can place the magazine clip 20 into the grip portion of the firearm 16 and load the firearm 16 with the bullet 14 for use thereof. The legs 12 of the firearm storage unit are disposed partially along the lengthwise sides thereof, centrally located and thus leaving space at the outer edge of the panel 13. The firearm storage unit 11 is not limited to a substantially rectangular shape and can be square, circular, triangular and/or other suitable shape.

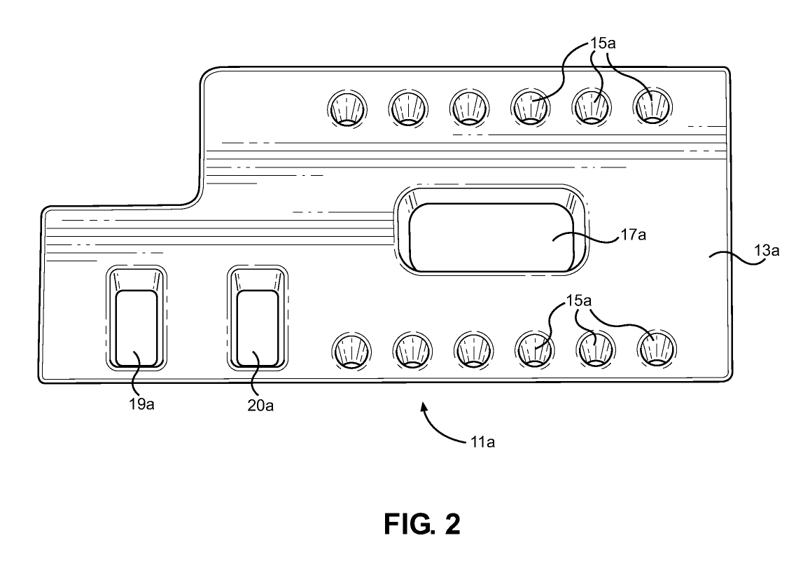

Referring now to FIG. 2, there is shown a top view of an alternate embodiment of the firearm storage unit 11a having a centrally located firearm slot 17a, a pair of slots for magazine clips 19a, 20a and a plurality of recessed holes 15a. The firearm storage unit 11a provides a panel 13a that comprises the top of the firearm storage unit 11 a wherein the panel 13a is substantially rectangular in shape in a preferred embodiment having a first side, a second side, and an outer edge. The first side of the panel 13a provides a centrally located first slot 17a having a rectangular shape in a preferred embodiment that is adapted to be utilized with a handgun type of firearm such as a pistol, a revolver and/or other suitable firearms. The first slot 17a provides an interior volume having an open upper, a base, and sidewalls defining an interior volume, in which the barrel portion of a firearm can be placed and can rest therein.

In the illustrated embodiment, the firearm storage unit 11 can accommodate two firearm magazine clips, and provides an extension portion forming a square shaped structure, extending from the outer edge of the firearm storage unit 11a, forming one unitary body. The firearm storage unit 11a provides a second slot 19a and a third slot 20a, each having a bottom end and sidewalls defining an interior volume and an open upper, wherein the second slot 19a and third slot 20a comprise a rectangular shape in a preferred embodiment being adapted to receive a firearm magazine clip therein. However, the second slot 19a and the third slot 20a need not provide sidewalls in an alternative embodiment defining an interior volume with a perimeter edge and may comprise rectangular shaped cutouts adapted to receive firearm magazine clips therein. There are legs (not shown) that are disposed along the lengthwise sides thereof, at the outer edge of the panel 13a.

The second slot 19a and the third slot 20a are adapted to be used with a standard magazine clip having cartridges, a top end, a base end, a magazine spring and a jacket, wherein the jacket comprises the housing of the magazine clip. The base end of the magazine clip provides a rim therearound of a substantial thickness, wherein the top end of the magazine clip is inserted into the second slot 19a or third slot 20a and the rim of the base end can extend over the perimeter edge of the open upper of the second or third slot 19a, 20a, thus resting flush against the first side of the panel 13a of the firearm storage unit 11 a in order to hang therefrom in the alternative embodiment. The firearm storage unit 11 a further includes a plurality of recessed holes 15a having a tubular structure located adjacent to the first slot 17a, wherein the recessed holes 15a comprise sidewalls and a bottom end defining an interior volume having an open upper that is circular shaped in order to be adapted to receive a standard bullet therein. The recessed holes 15a can be made in various sizes and/or shapes in order to be utilized with different types of bullets.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A firearm storage unit for a center console of a vehicle, comprising:
a panel adapted to be disposed in a horizontal orientation, said panel having an outer edge, a first side, and a second side;
a first slot disposed on said panel, said first slot having sidewalls, a base, and an open upper, defining an interior volume adapted to receive a firearm therein;
at least one recessed hole disposed on said panel, said at least one recessed hole having sidewalls, a base, and an open upper, defining an interior volume adapted to receive a bullet therein;
at least one second slot, said at least one second slot having sidewalls defining an interior volume, a base and an open upper adapted to receive a magazine therein;
at least one leg, said at least one leg being disposed on said outer edge of said panel.

2. The firearm storage unit of claim 1, wherein said first slot is centrally disposed on said panel.

3. The firearm storage unit of claim 1, wherein said at least one second slot comprises a pair of second slots.

4. The firearm storage unit of claim 1, wherein said at least one hole is a plurality of holes disposed on each side of said first slot.

5. The firearm storage unit of claim 1, wherein said at least one hole is a plurality of holes disposed in a linear arrangement.

6. The firearm storage unit of claim 1, wherein said at least one leg further comprises a pair of legs.

7. The firearm storage unit of claim 1, wherein said panel comprises a substantially rectangular shape.

8. The firearm storage unit of claim 1, wherein said panel comprises a substantially square shape.

9. The firearm storage unit of claim 1, wherein said panel is substantially planar.

10. The firearm storage unit of claim 1, wherein said panel is composed of a plastic material.

11. The firearm storage unit of claim 1, wherein said at least one recessed hole comprises a circular shape.
